(19) United States
(12) Patent Application Publication
(10) Pub. No.: US 2009/0116056 A1
(43) Pub. Date: May 7, 2009

(54) IMAGE PROCESSING APPARATUS

(75) Inventor: Kenji DOKUNI, Kyoto-shi (JP)

Correspondence Address: MURATA MACHINERY, LTD.;(MURATEC) c/o KEATING & BENNETT LLP, 1800 Alexander Bell Drive, SUITE 200, Reston, VA, 20191, US

(73) Assignee: MURATA MACHINERY, LTD., Kyoto-shi (JP)

(21) Appl. No.: 12/211,839

(22) Filed: Sep. 17, 2008

(30) Foreign Application Priority Data
Nov. 6, 2007 (JP) 2007-288051

(51) Int. Cl. G06F 3/12

(52) U.S. Cl. 358/1.15

(57) ABSTRACT

An image processing apparatus includes an image scanner unit arranged to generate image data by scanning an original document, at least two output units arranged to output the image data scanned by the image scanner unit, a data table arranged to store a destination with respect to each output unit for at least two recipients, an output specifying unit arranged to specify, in advance with respect to each recipient, the valid output unit for the recipient to receive the image data, a recipient specifying unit arranged for the operator to specify the recipient at the time of output of the image data, and an output control unit arranged to determine a destination based on the data table, the valid output unit specified by the output specifying unit, and the recipient specified by the operator by using the recipient specifying unit, and to output the image data via the output unit that corresponds to the destination.

### CROSS-REFERENCE TO RELATED APPLICATION

This application claims priority under 35 U.S.C. 119 to Japanese Patent Application No. 2007-288051, filed on Nov. 6, 2007, which application is hereby incorporated by reference in its entirety.

### BACKGROUND OF THE INVENTION

1. Field of the Invention

The present invention relates to an image processing apparatus capable of outputting image data to a recipient via a network and a public line. More particularly, the present invention relates to an image processing apparatus capable of outputting image data substantially simultaneously to a plurality of recipients.

2. Description of the Related Art

Recently, an image processing apparatus, such as an image scanner, has been suggested which includes a system that can transmit scanned image data to a recipient via a network.

For example, in a Multi Functional Peripheral (MFP) including a plurality of functions such as a scanner function, a copier function, and a printer function, an MFP has been suggested which stores image data in a memory arranged within the MFP that can be accessed from outside via a network so that an outside user can receive the image data.

In an MFP of the above-described conventional type, (1) an operator transmits image data to a folder of a Personal Computer (PC) of a recipient via a Local Area Network (LAN), (2) image data is transmitted through the Internet to a PC of a recipient by an electronic mail (e-mail), (3) image data is transmitted via facsimile to a recipient; and (4) image data is stored in a recipient's special folder included in the MFP.

A conventional image processing apparatus can broadcast image data to a plurality of recipients using an e-mail. Moreover, the image processing apparatus stores an e-mail address, which is a receiving destination of a recipient, and a destination attribute of the of the recipient in a storage device. The destination attributes indicate communication conditions, such as whether or not to display a transmission source, or to attach a cover page at the time of transmission of the image data and the conditions of a receiving ability.

In such an image processing apparatus, when an operator transmits the image data to the plurality of recipients, the recipients are grouped based on the destination attributes, and the image data is broadcasted to the plurality of recipients with respect to each group.

In another image processing apparatus, when image data is transmitted to a recipient via a network, an operator first notifies the recipient using an e-mail that the image data is stored in the image processing apparatus. Then, when the recipient needs to receive the image data, the recipient transmits an instruction to the image processing apparatus indicating a need for the image data that has transmitted the notifying e-mail. In response to the instruction, the image processing apparatus transmits the image data to the recipient. When the recipient transmits the instruction to the image processing apparatus, the image processing apparatus can specify a transmission destination to which the image data is transmitted.

In an image processing apparatus capable of outputting image data to a plurality of recipients via a network and a Public Switched Telephone Network (PSNT), some recipients wish to receive the image data in a desired receiving format (hereinafter referred to as an output format). The output formats in which the image data is output include transmission via an e-mail to a PC of the recipient, transmission via a LAN to a storage device of the PC of the recipient, transmission by a facsimile machine that is connected to the PSTN, and storage in a storage device of a server provided in the image processing apparatus.

In order to respond to such a plurality of output formats, some image processing apparatuses register destinations in at least two output formats with respect to each recipient. In such image processing apparatuses, when an operator transmits the image data to the plurality of recipients, the operator has to specify not only the recipient from a recipient data table registered in the image processing apparatus, but also the destination desired by each recipient from a plurality of destinations registered with respect to each recipient. As a result, the operator has an increased number of choices which thereby complicates the operation. Accordingly, the operator has to recognize not only the recipient but also the destination desired by the recipient. As the number of recipients registered in the data table increases, the necessity to search for a prescribed recipient from the plurality of recipients also increases, further burdening the operator.

In the above-described conventional image processing apparatus, grouping is performed based on the destination attribute, and the image data is always broadcasted to each group via an e-mail. Therefore, a desired output format cannot be selected in the conventional image processing apparatus. If the image processing apparatus is set to be capable of selecting a plurality of output formats, an operation to specify the destination desired by the recipient with respect to each recipient in the group is required, thereby substantially complicating the operation of the operator.

In the other conventional image processing apparatus, although the recipient can eventually specify the desired destination, the operator first transmits an e-mail notifying the existence of the image data to the recipient. Accordingly, the process in which the recipient of the e-mail transmits to the image processing apparatus the instruction for requiring the image data, the image processing apparatus transmits the image data to the recipient in response to the instruction, and the recipient receives the image data is extremely cumbersome.

### SUMMARY OF THE INVENTION

In order to overcome the problems described above, preferred embodiments of the present invention provide an image processing apparatus that can reliably output image data to a destination desired by each recipient by a simple operation. This simple operation works even when destinations in at least two output formats are registered in the image processing apparatus with respect to each recipient, and when the image processing apparatus outputs the image data in different output formats with respect to a plurality of recipients.

A preferred embodiment of the present invention provides an image scanner unit arranged to generate image data by scanning an original document, at least two output units arranged to output the image data scanned by the image scanner unit, a data table arranged to store a destination with respect to each output unit for at least two recipients, an output specifying unit arranged to specify in advance, with respect to each recipient, the output unit that is valid for the recipient to receive the image data, a recipient specifying unit arranged to specify the recipient by an operator at the time of output of the image data, and an output control unit arranged to determine the destination based on the data table, the valid output unit specified by the output specifying unit, and the recipient specified by the operator by using the recipient specifying unit, and to output the image data via the output unit that corresponds to the destination.

The output unit may preferably be a unit that transmits the image data by an e-mail to a PC of the recipient, a unit that transmits the image data to a storage device of the PC of the recipient via a LAN, a unit that transmits the image data via a facsimile unit that is connected to a PSTN, and/or a unit that stores the image data in a storage device of a server arranged in an image processing apparatus. The unit that transmits the image data to the storage device of the PC of the recipient via the LAN preferably is a data communication unit that writes in the storage device of the PC and uses an Internet Protocol (IP).

In the data table, at least two output units with respect to each recipient are associated and registered, and the destination is also registered with respect to each output unit. For example, an e-mail address is registered as the destination for the transmission via the e-mail, the telephone number is registered as the destination for the transmission via facsimile, a Uniform Resource Locator (URL) of a folder of the storage device of the PC is registered as the destination for the transmission via the LAN, and a directory of a recipient's special folder provided in the storage device is registered as the destination for the storage in the storage device of the server provided in the image processing apparatus.

The valid output unit is the output unit that is selected by the recipient from a plurality of output units registered in the data table with respect to the relevant recipient. The image data is output from the selected output unit. Since the valid output unit, that is, the output unit desired by the recipient for receiving the image data, is specified in advance by the output specifying unit with respect to each recipient, the operator has only to specify a prescribed recipient and the image data is automatically output by the output unit specified in advance.

A plurality of output units are registered in the data table with respect to each recipient, and the destinations such as the e-mail address, facsimile number, URL, and/or directory of the folder are associated with the respective output units and registered in the data table. Since the recipient specifies the desired valid output unit in advance by using the output specifying unit, when the operator specifies the recipient by using the recipient specifying unit, the image data is automatically transmitted by the output unit desired by the recipient to the destination that corresponds to the desired output unit. The operator does not have to be attentive to the output unit desired by the recipient, and only has to specify the recipient so as to reliably transmit the image data to the destination desired by the recipient with respect to each of the plurality of recipients.

According to a preferred embodiment of the present invention, at least two valid output units are specified with respect to each recipient by the output specifying unit. Since a plurality of valid output units are specified with respect to each recipient, the recipient receives the image data via the plurality of desired output destinations. Moreover, even when the operator transmits the image data to the plurality of destinations with respect to each recipient, the operator can complete the operation by specifying only the recipient, without specifying the plurality of destinations. In other words, regardless of the number of destinations, the operator can complete the transmission by specifying only the recipient.

A preferred embodiment of the present invention provides an output result storage unit arranged to store output results generated by the output unit at the time of output of the image data, an output result notifying unit arranged to output the output result as a communication report, and an output format specifying unit arranged to specify, as an output format of the communication report, either one of (1) an output format in which the output result is output with respect to each recipient, or (2) an output format in which the output result is output with respect to each destination. Furthermore, the output result notifying unit outputs the communication report based on the output format specified by the operator. The operator obtains the output result via the communication report in the desired output format.

A preferred embodiment of the present invention provides an output result storage unit arranged to store the output results generated by the output unit at the time of output of the image data, an error information generating unit arranged to determine one of a normal operation or an error, and to generate error information, a determination standard specifying unit arranged for the operator to select, as a determination standard of the normal operation or the error, either one of a first determination standard by which the error is determined when all the destinations with respect to one recipient is the error, or a second determination standard by which the error is determined when one of the destinations with respect to one recipient is the error, and the output result notifying unit is arranged to output a communication report including the error information. In such a configuration, the operator obtains the output result including the error information in a desired format via the communication report.

According to a preferred embodiment of the present invention, the output units include at least two output units that are selected from a first output unit that transmits via e-mails, a second output unit that transmits via a facsimile unit that is connected with the PSTN, a third output unit that transmits via a LAN, and a fourth output unit that stores an output in a storage unit that corresponds to a recipient and is arranged in a server of the image processing apparatus. At least two output units among the above-described four output units are provided in the image processing apparatus depending on an intended use, and the valid output unit is selected from the provided output units.

According to a preferred embodiment of the present invention, because the valid output unit desired by each recipient is specified in advance, when image data is output to a plurality of recipients, the image data can be automatically transmitted to the destination desired by each of the recipients by a simple operation of specifying the recipient even if the valid output unit differs among each of the recipients.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a block diagram illustrating a schematic configuration of an MFP according to a preferred embodiment of the present invention.

FIG. 2 is a block diagram illustrating a functional configuration of a control unit of the MFP of FIG. 1.

FIG. 3 illustrates a first user information setting screen displayed when the MFP transmits image data.

FIG. 4 illustrates a second user information setting screen displayed when the MFP sets the transmission conditions of image data.

### DETAILED DESCRIPTION OF PREFERRED EMBODIMENTS

An MFP defining an image processing apparatus according to preferred embodiments of the present invention will be described. The MFP preferably includes a copy function, a scanner function, a print function, a facsimile communication function, and a data storage function.

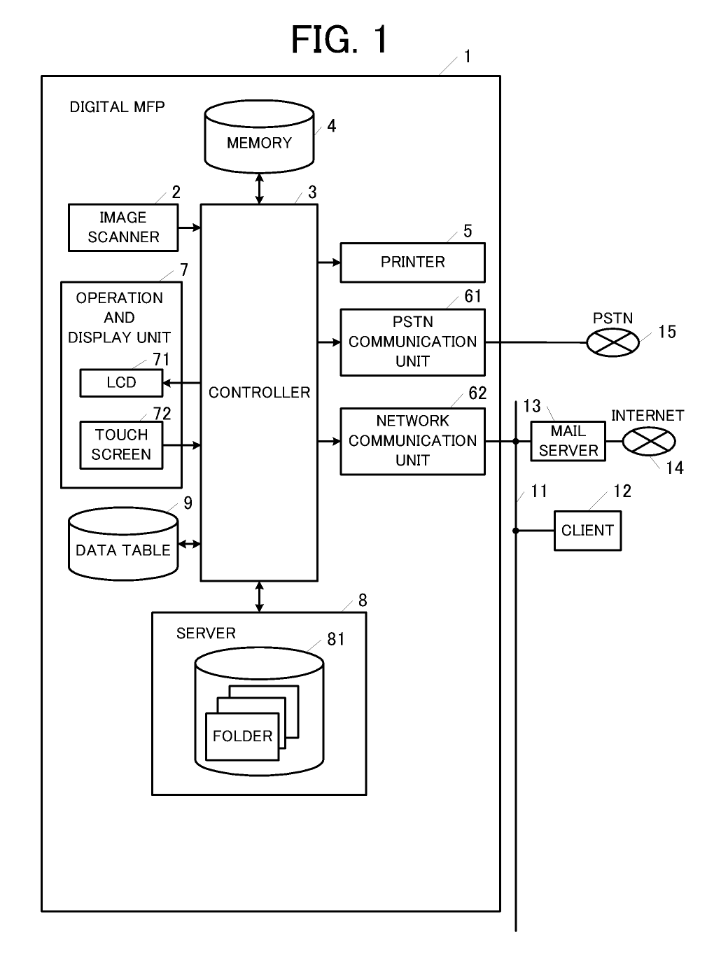

As illustrated in a block diagram of a schematic configuration of FIG. 1, an MFP 1 is connected via a LAN 11 with a client terminal device 12 and a mail server 13, or the like, such that the MFP 1 can communicate with the client terminal device 12 and the mail server 13. The mail server 13 is connected to the Internet 14 such that the server 13 can communicate with the Internet 14, and e-mails can be transmitted and received via the Internet 14. Moreover, the MFP 1 is also connected with a PSTN 15 such that the MFP 1 can communicate with the PSTN 15, and image data can be transmitted to and received from a plurality of facsimile machines via the PSTN 15.

The MFP 1 preferably includes an image scanner 2, a controller 3, a memory 4, a printer 5, a PSTN communication unit 61, a network communication unit 62, an operation and display unit 7, a server 8, and a data table 9.

The image scanner 2 optically scans an original document and generates image data formed of pixel data. For example, light is irradiated on the original document, and by scanning the irradiated light, an image can be scanned from the original document. Here, the pixel data formed of each intensity data of color components of Red, Green, and Blue (RGB) is generated. Since the pixel data is of an RGB calorimetric system, the data is converted into a YCbCr calorimetric system formed of a luminance component (Y) and color difference components (Cb and Cr), and output as the image data.

The controller 3 controls operations of the entire MFP 1. For example, the controller 3 compresses the image data scanned by the image scanner 2 and image data received via facsimile or an e-mail by using a prescribed compression method such as a Joint Photographic Experts Group (JPEG), and stores the compressed data in the memory 4.

The memory 4 includes a Read Only Memory (ROM) in which control programs, etc., are stored and a Random Access Memory (RAM) that stores the compressed image data, for example.

The printer 5 is an image outputting device that prints the image on a sheet of paper based on the image data output by the controller 3. If needed, the controller 3 expands the compressed data and outputs the expanded image data to the printer 5.

The PSTN communication unit 61 transmits or receives the image data via the PSTN 15, and controls the connection of the PSTN 15 with a telephone exchange office, for example. The controller 3 outputs, as transmission data, the compressed data read out from the memory 4 to the PSTN communication unit 61 and stores the image data received by the PSTN communication unit 61 in the memory 4.

The network communication unit 62 transmits and receives the image data to and from the client terminal device 12 and the mail server 13 via the LAN 11. The controller 3 outputs, as transmission data, the compressed data read out from the memory 4 to the network communication unit 62 and stores the image data received by the network communication unit 62 in the memory 4.

The operation and display unit 7 is a user interface that includes, for example, a Liquid Crystal Display (LCD) 71 having a display screen preferably having a rectangular shape and a touch screen 72. The display screen of the LCD 71 displays the image data generated by the image scanner 2, the image data received by the PSTN communication unit 61 or the network communication unit 62, and operation information or the like. The touch screen 72 is an operation inputting unit that is arranged on the display screen of the LCD 71, detects operations by an operator, and generates prescribed operation input data in accordance with operation positions.

When displaying the image data, the controller 3 reads out the compressed data from the memory 4 and expands the data in accordance with the operation input data. The controller 3 reduces the expanded image data, such that the number of pixels is reduced, and performs an operation of outputting the reduced image data to the LCD 71. For example, when the image data is scanned from the original document, or when the image data is received, the reduced image data is displayed on the LCD 71. When the image data is printed or transmitted, the image data is displayed on the LCD 71 as a preview.

The server 8 can store the image data and various other pieces of information. When a request for data acquirement is made from the client terminal device 12, the server 8 reads out the required data from a memory arranged in the server 8 and transmits the data to the client terminal device 12 which has requested for acquiring the data. The server 8 includes an image memory 81 in which the image data is stored. The image memory 81 stores the image data scanned by the image scanner 2 and the image data received by the PSTN communication unit 61 and the network communication unit 62. In the image memory 81, a plurality of folders in which the image data is stored are associated and provided with respect to each client.

In the data table 9, recipient information for transmitting the image data to a prescribed recipient via the PSTN communication unit 61 and the network communication unit 62 is registered. In the data table 9, at least two output units are associated with respect to each recipient, and a destination is stored with respect to each output unit.

More specifically, a recipient name, a company name, a telephone number, a facsimile number, an e-mail address, a URL of a folder of the client terminal 12, a directory of a folder, etc. of the image memory 81 arranged in the server 8 of the MFP 1 can be registered in the data table 9.

An output unit 36 includes (1) an output unit 36a (hereinafter referred to as a FAX output unit) that transmits via facsimile, (2) an output unit 36b (hereinafter referred to as an e-mail output unit) that transmits via an e-mail, (3) an output unit 36c (hereinafter referred to as a client output unit) that transmits via the LAN to the client terminal device 12, and (4) an output unit 36d (hereinafter referred to as a server output unit) that stores in a folder that is associated with the recipient and is arranged in the image memory 81 of the server 8.

The facsimile number corresponds to the destination of the FAX output unit 36a. The e-mail address corresponds to the destination of the e-mail output unit 36b. The URL of the folder of the client terminal device 12 corresponds to the destination of the client output unit 36c. The directory of the folder of the image memory 81 corresponds to the destination of the server output unit 36d.

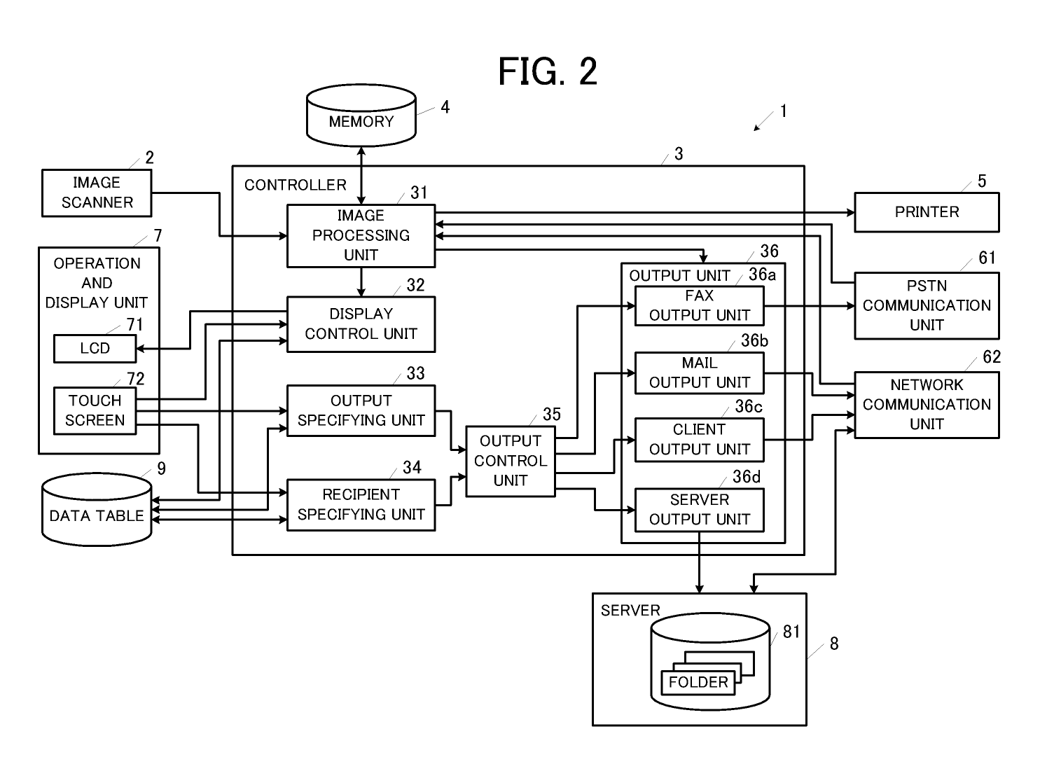

FIG. 2 is a block diagram illustrating an example of a configuration of a main portion of the MFP 1 of FIG. 1, and illustrates an example of a functional configuration of the controller 3. The controller 3 preferably includes an image processing unit 31, a display control unit 32, an output specifying unit 33, a recipient specifying unit 34, an output control unit 35, and the output unit 36.

The image processing unit 31 compresses and expands the image data by using a JPEG method. The image processing unit 31 converts uncompressed image data into compressed data to store in the memory 4. A compressing process of the image data reduces an amount of data by using a statistical operation of pixels. The compressed data stored in the memory 4 is expanded by the image processing unit 31. When displaying the expanded image data in a reduced size on the LCD 71, the image processing unit 31 reduces the image data. In the reduction of the image data, the expanded image data is converted such that the number of pixels is reduced, and the reduced image data is generated. When printing the image data by the printer 5, the image data is output from the image processing unit 31 to the printer 5, and the image is printed on a sheet of paper or the like.

The display control unit 32 displays the image data in a prescribed size on the LCD 71 of the operation and display unit 7, and controls the display of operation information based on the operations of the operator. On the LCD 71, the image data or information for the operations is displayed on the display screen by the output from the display control unit 32.

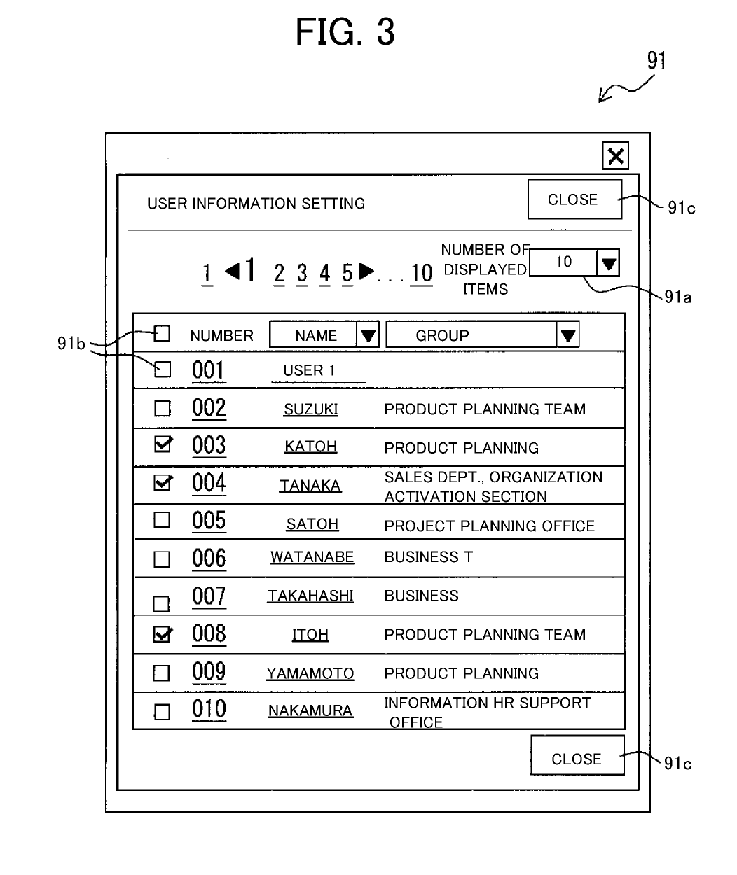

When transmitting the image data to a prescribed recipient via e-mail or the like, the MFP 1 reads out a list of recipients from the data table 9 by using the display control unit 32. The display control unit 32 displays on the LCD 71 a first user information setting screen 91 on which the list of recipients is displayed as illustrated in FIG. 3.

The first user information setting screen 91 illustrated in FIG. 3 displays a list of a user name of the recipient, a number, and a group name to which the recipient belongs in a company, for example. In the present preferred embodiment, the number, the user (recipient) name, and the group name are preferably sequentially displayed from the left. In the MFP 1, a number of displayed items setting box 91a is arranged for setting the number of items displayed on one display screen, and the desired number of items to be set is displayed in the number of displayed items setting box 91a. When the number of registered users is large, the number is displayed in a plurality of pages, and list displaying status can be selected.

Furthermore, on the first user information setting screen 91, a check box 91b is preferably arranged on the left side of each number, and the check box 91b is set to be checked by operating the touch screen 72.

On the first user information setting screen 91, a close button 91c is preferably arranged on an upper portion and a lower portion of the screen. These close buttons 91c are icons for closing the first user information setting screen 91.

In the MFP 1, after the close button 91c is specified in a state in which the check box 91b is checked, and the first user information setting screen 91 is closed, preferably, the image data is transmitted to the checked recipient when the operator presses a start key (not illustrated).

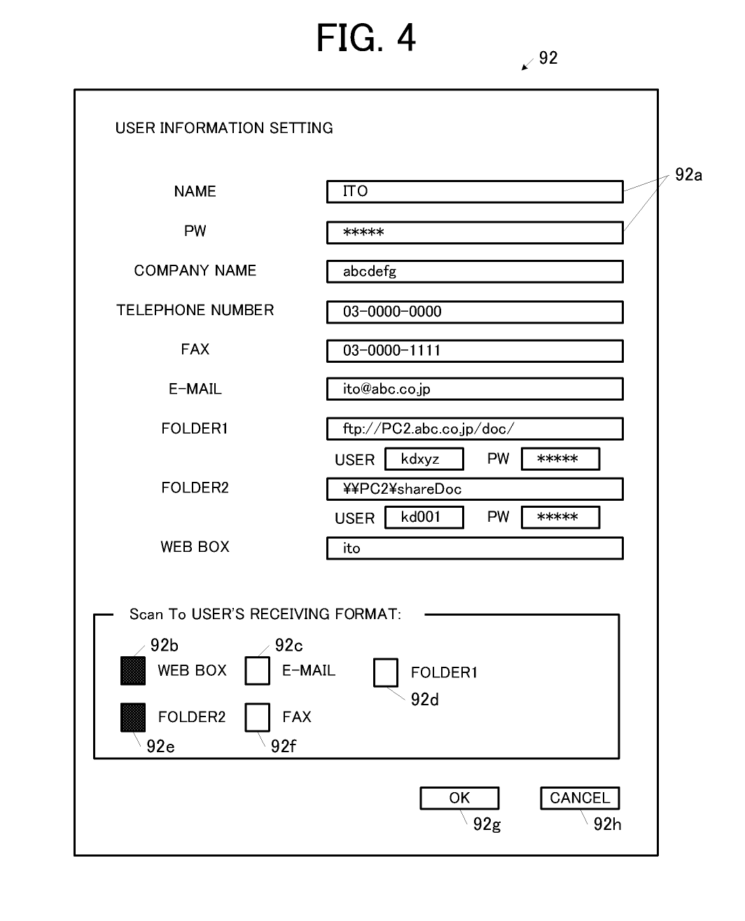

Furthermore, in the MFP 1, the display of the first user information setting screen 91 can be changed to the display of a second user information setting screen 92 that is provided to set user information (registered information) of one recipient as illustrated in FIG. 4.

More specifically, when setting the user information, the recipient that corresponds to the user information or an administrator first operates the touch screen 72 in a state in which the first user information setting screen 91 is displayed, and specifies the number or name of the recipient. When the number or name of the recipient is specified, the MFP 1 displays the second user information setting screen 92 for displaying the registered information of the recipient. When changing the set content of the second user information setting screen 92, the set content cannot be changed unless an ID or a password of the recipient or administrator is input.

The second user information setting screen 92 displays the user information of one recipient, and by operating the touch screen 72, the settings of various pieces of information can be performed. The settable items are, for example, a name of the recipient, a password (refer to “PW” in FIG. 4), a company name, a telephone number, a telephone number for facsimile (refer to “FAX” in FIG. 4), an e-mail address (refer to “mail” in FIG. 4), a URL (refer to “folder1” in FIG. 4) of a File Transfer Protocol (FTP) of a folder 1 of the client terminal device 12, an address (refer to “folder2” in FIG. 4) using a Universal Naming Convention (UNC) method of a shared document folder 2 of the client terminal device 12, and a directory (refer to “web box” in FIG. 4) of a folder of the image memory 81 in the MFP 1. Preferably a box 92a for setting is arranged on the right side of these items. By operating the touch screen 72, the prescribed item content is set in each box 92a for setting, and each item of information is registered in the data table 9 with respect to each recipient.

When transmitting the image data scanned by the image scanner 2 to the recipient via the LAN 11, the output specifying unit 33 illustrated in FIG. 2 specifies in advance the output unit valid for the recipient to receive the image data.

In the present preferred embodiment, by using the second user information setting screen 92 illustrated in FIG. 4, the output unit used when transmitting the image data read by the image processing unit 31 to the recipient can be specified from the FAX output unit 36a, the e-mail output unit 36b, the client output unit 36c, and the server output unit 36d. A section of “Scan To User's Receiving Format” for specifying the valid output unit is arranged below the box 92a for setting on the second user information setting screen 92. Five output units, that is, the “web box”, “e-mail”, “folder1”, “folder2”, and “FAX” are displayed in the section of “Scan To User's Receiving Format”.

The “web box” corresponds to the server output unit 36d, the “e-mail” corresponds to the e-mail output unit 36b, the “folder1” and “folder2” correspond to the client output unit 36c, and “FAX” corresponds to the FAX output unit 36a. A desired output unit (36a through 36d) can preferably be specified by checking each check box 92b through 92f arranged beside these output units.

When storing the image data in the folder of the image memory 81 of the MFP 1, the check box 92b of “web box” is checked. When transmitting the image data via the e-mail, the check box 92c of “e-mail” is checked. When transmitting the image data to the client terminal device 12 via the LAN 11, the check box 92d or 92e of “folder1” or “folder2” is checked in accordance with the address of the folder. When transmitting the image data via facsimile, the check box 92f of “FAX” is checked. In the MFP 1, only one output unit or at least two output units can be specified.

An OK button 92g and a cancel button 92h are preferably arranged on a lower portion of the second user information setting screen 92. The OK button 92g is an icon for registering, when the setting content is changed, the changed setting content in the data table 9 and for closing the second user information setting screen 92 to redisplay the first user information setting screen 91. The cancel button 92h is an icon for closing the second user information setting screen 92 to redisplay the first user information setting screen 91.

When an operator outputs the image data read by the image processing unit 31 to a prescribed recipient, the operator specifies the prescribed recipient by using the recipient specifying unit 34 illustrated in FIG. 2. In the MFP 1, the recipient is specified by using the first user information setting screen 91 illustrated in FIG. 3.

As described above, the check box 91b is preferably arranged on the left side of each number on the first user information setting screen 91, and when transmitting the image data, the touch screen 72 is operated, and the check box 91b of the recipient to which the image data is transmitted is checked. The recipient to which the image data is transmitted is specified when the check box 91b of the recipient is checked. At this time, the check boxes 91b of a plurality of recipients may be checked to broadcast to the plurality of recipients.

The output control unit 35 illustrated in FIG. 2 determines the destination based on the valid output unit specified by the output specifying unit 33 and on the recipient specified by the operator by using the recipient specifying unit 34, and outputs the image data via the output unit that corresponds to the destination.

In the MFP 1, the output control unit 35 uses the first user information setting screen 91 illustrated in FIG. 3 to specify the prescribed output unit, and controls the transmission of the image data to the recipient via the specified output unit. In other words, when transmitting the image data, the touch screen 72 is operated first, the close button 91c is specified in a state in which the check box 91b that corresponds to the desired recipient is checked on the first user information setting screen 91, and then the first user information setting screen 91 is closed.

Then, the operator presses the start key (not illustrated), and the image data is transmitted to the checked recipient via the specified output unit. Thus, the output control unit 35 uses the valid output unit specified in advance by the output specifying unit 33, and controls the transmission of the image data. When the check boxes 91b of the plurality of recipients are checked, the data is broadcasted to the plurality of recipients.

As described above, the output unit 36 includes the FAX output unit 36a, the e-mail output unit 36b, the client output unit 36c, and the server output unit 36d. When the destination is determined by the output control unit 35, the output control unit 35 selects the output unit that corresponds to the destination from the FAX output unit 36a, the e-mail output unit 36b, the client output unit 36c, and the server output unit 36d. Then, the image data is transmitted to the destination of the specified recipient via the selected output unit.

The FAX output unit 36a outputs the image data to transmit via facsimile based on a control instruction from the output control unit 35. The e-mail output unit 36b outputs the image data to transmit via the e-mail based on the control instruction from the output control unit 35. The client output unit 36c outputs the image data to transmit to the client terminal device 12 via the LAN based on the control instruction from the output control unit 35. The server output unit 36d outputs the image data to store in the folder that corresponds to the recipient and is in the image memory 81 of the server 8, based on the control instruction from the output control unit 35.

In the MFP 1, since the output unit desired by the recipient is specified in advance by using the second user information setting screen 92 by the output specifying unit 33, the operator can transmit the image data to the destination desired by each recipient, by a simple operation such as specifying the recipient and pressing the start key.

Furthermore, according to a preferred embodiment of the present invention, the image processing apparatus preferably includes an output result storage unit that stores output results generated by the output unit at the time of output of the image data, an output result notifying unit that outputs the output result as a communication report, and an output format specifying unit that is provided for the operator to specify one of an output format of the communication report, an output format in which one output result is output with respect to each recipient, and an output format in which one output result is output with respect to each destination. In this case, the output result notifying unit outputs the communication report based on the output format specified by the operator. In this configuration, the operator can acquire the output result in the desired output format as the communication report.

Furthermore, according to a preferred embodiment of the present invention, the image processing apparatus preferably includes an output result storage unit that stores output results generated by the output unit at the time of output of the image data, an error information generating unit that determines a normal operation or an error based on the output result and that generates error information, a determination standard specifying unit that is provided for the operator to select, as a determination standard of the normal and the error, either one of an error determination standard that determines the error when all the destinations of the same recipient indicate the error, or a determination standard that determines the error when one of the destinations of the same recipient indicates the error. In such a configuration, the operator can acquire the communication report of the output result including the error information in a desired format.

While the present invention has been described with respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image processing apparatus comprising:
an image scanner unit arranged to generate image data by scanning an original document;
at least two output units arranged to output the image data scanned by the image scanner unit;
a data table arranged to store a destination with respect to each output unit for at least two recipients;
an output specifying unit arranged to specify in advance, with respect to each recipient, a valid output unit for the recipient to receive the image data;
a recipient specifying unit arranged to allow an operator to specify the recipient at the time of output of the image data; and
an output control unit arranged to determine a destination based on the data table, the valid output unit specified by the output specifying unit, and the recipient specified by the operator by using the recipient specifying unit, in order to output the image data via the output unit that corresponds to the destination.

2. The image processing apparatus according to claim 1, wherein the output specifying unit specifies at least two valid output units with respect to each recipient.

3. The image processing apparatus according to claim 2, further comprising:
an output result storage unit arranged to store output results generated by the output unit at the time of output of the image data;
an output result notifying unit arranged to output the output result as a communication report; and
an output format specifying unit arranged to allow the operator to specify, as an output format of the communication report, either one of a first output format in which one output result is output with respect to each recipient, and a second output format in which one output result is output with respect to each destination.

4. The image processing apparatus according to claim 2, further comprising:
an output result storage unit arranged to store output results generated by the output unit at the time of output of the image data;
an error information generating unit arranged to determine a normal operation or an error based on the output result, and to generate error information;
a determination standard specifying unit arranged to allow the operator to select, as a determination standard of the normal operation and the error, either one of a first determination standard that determines the error when all the destinations of one recipient indicate the error, and a second determination standard that determines the error when one of the destinations of one recipient indicates the error; and
an output result notifying unit arranged to output a communication report including the error information.

5. The image processing apparatus according to claim 1, further comprising:
a first output unit arranged to transmit information via an e-mail;
a second output unit arranged to transmit information via a facsimile unit that is connected with a Public Switched Telephone Network;
a third output unit arranged to transmit information via a Local Area Network; and
a fourth output unit arranged to store information in a storage unit that corresponds to the recipient and is arranged in a server of the image processing apparatus.

6. The image processing apparatus according to claim 5, wherein the output format specifying unit specifies at least two output units from the first output unit, the second output unit, the third output unit, and the fourth output unit.

7. The image processing apparatus according to claim 1, further comprising a display unit arranged to display content from a data table.

8. The image processing apparatus according to claim 7, wherein the display unit displays the data table content as a list of recipients.

9. The image processing apparatus according to claim 8, wherein the display unit displays the output units specified with respect to the recipient from the data table content.

10. The image processing apparatus according to claim 8, further comprising a touch screen provided with the display unit.

11. The image processing apparatus according to claim 10, wherein the recipient is specified by touching one of the list of recipients which are displayed on the touch screen of the display unit.

12. An image processing apparatus comprising:
a generating device arranged to generate image data by scanning an original document;
an image data outputting device arranged to output the image data generated by the generating device via an output unit;
a destination memory device arranged to store a destination with respect to each output unit for at least two recipients in a data table;
an output specification device arranged to specify in advance, with respect to each recipient, a valid output unit for the recipient to receive the image data;
an recipient operation interface device arranged to permit an operator to specify the recipient at the time of output of the image data; and
a determination device arranged to determine a destination based on the data table, the specified valid output unit, and the recipient specified by the operator, and to output the image data via the output unit that corresponds to the destination.

13. The image processing apparatus according to claim 12, wherein at least two valid output units are specified with respect to each recipient.

14. The image processing apparatus according to claim 13, further comprising:
an output memory device arranged to store output results generated by the output unit at the time of output of the image data;
a result outputting device arranged to output the output result as a communication report; and
a format specification device arranged to allow the operator to specify, as an output format of the communication report, either one of a first output format in which one output result is output with respect to each recipient, and a second output format in which one output result is output with respect to each destination.

15. The image processing apparatus according to claim 13, further comprising:
a results memory device arranged to store output results generated by the output unit at the time of output of the image data;
an error determination device arranged to determine a normal operation and an error based on the output result and for generating error information;
a selection device arranged to allow the operator to select, as a determination standard of the normal operation and the error, either one of a first determination standard that determines the error when all the destinations with respect to one recipient indicate the error, and a second determination standard that determines the error when one of the destinations with respect to one recipient indicates the error; and
an output device arranged to output the communication report including the error information.

16. The image processing apparatus according to claim 12, further comprising:
an e-mail transmission device arranged to transmit information via an e-mail;
a fax transmission device arranged to transmit information via a facsimile unit that is connected with a Public Switched Telephone Network;
a network transmission device arranged to transmit information via a Local Area Network; and
a recipient memory device arranged to store information that corresponds to the recipient and is arranged in a server of the image processing apparatus in a storage unit.

17. The image processing apparatus according to claim 12, further comprising a table content displaying device arranged to display a data table content.

18. The image processing apparatus according to claim 17, further comprising a list displaying device arranged to display the data table content as a list of recipients.

19. The image processing apparatus according to claim 17, further comprising an output display device arranged to display the output unit specified with respect to each recipient from the data table content.
